(19) United States
(12) Patent Application Publication
(10) Pub. No.: US 2022/0089239 A1
(43) Pub. Date: Mar. 24, 2022

(54) Universal Mounting Panel for a Motorcycle Saddlebag

(71) Applicant: Kenneth Wayne Schepers, Burleson, TX (US)

(72) Inventor: Kenneth Wayne Schepers, Burleson, TX (US)

(21) Appl. No.: 17/478,816

(22) Filed: Sep. 17, 2021

Related U.S. Application Data
(63) Continuation-in-part of application No. 29/751,243, filed on Sep. 18, 2020.
(60) Provisional application No. 63/080,605, filed on Sep. 18, 2020.

(51) Int. Cl. B62J 9/27

(52) U.S. Cl. CPC B62J 9/27

(57) ABSTRACT

A universal mounting panel for a motorcycle saddlebag is an apparatus that serves as a universal mounting system for motorcycles. The apparatus includes an adapter plate and at least one bracket. The adapter plate positions and connects the at least one bracket. The at least one bracket mounts a desired accessory within the saddlebag. The adapter plate includes an elongated plate body, a main hole, a plurality of first mounting holes, at least one left slot, and at least one right slot. The elongated plate body upholds the at least one bracket. The main hole allows a twist lock to fasten the elongated plate body with the saddlebag. The plurality of first mounting holes secures the position of the at least one bracket along the elongated plate body. The at least one left slot and the at least one right slot allows the at least one bracket to be angled.

The current application claims a priority to the U.S. Provisional Patent application Ser. No. 63/080,605 filed on Sep. 18, 2020.

The current application is also a continuation-in-part (CIP) application of the U.S. design application Ser. No. 29/751,243 filed on Sep. 18, 2020.

### FIELD OF THE INVENTION

The present invention generally relates to saddlebag accessories for a motorcycle or comparable vehicle. More specifically, the present invention mounting panel that provides multiple configurations for adaptable holsters, pouches, and a variety of other equipment that are mounted to load bearing equipment.

### BACKGROUND OF THE INVENTION

Cargo space is a precious commodity on a motorcycle, generally limited to items stowed in form-fit bags and hard-cases mounted to the left and right of the rear tire. These are colloquially known as ‘saddle bags’, in reference to similar implements fastened to horses for similar purposes, i.e., expanding storage space. Unlike the equestrian version, modern saddle bags must be balanced and packed carefully to avoid excessive weight shift and prevent potentially hazardous loss of balance during banking turns. Additionally, these saddle bags are often used to stow essential tools or even personal weapons that need to be close at hand or readily accessible to be effective. A rider cannot afford to sift through their bags in search of some essential equipment, particularly a handgun in self-defense. However, any such equipment would be valuable, or potentially dangerous in the case of weapons, and would thus be unsuitable for storage outside of a saddlebag or other sealable case. It is therefore proposed that a means for rigidly mounting and arranging equipment within a saddlebag may enable a rider to keep their equipment close at hand, while still retaining the ability to lock up said equipment in position while not in use.

### BRIEF DESCRIPTION OF THE DRAWINGS

FIG. 1 is a front perspective view of an adapter plate of the present invention.

FIG. 2 is a front perspective view of the adapter plate with a first bracket of the present invention.

FIG. 3 is an exploded rear perspective view of the adapter plate with the first bracket of the present invention.

FIG. 4 is a front perspective view of the adapter plate with the first bracket and a twist lock of the present invention.

FIG. 5 is an exploded front perspective view of the adapter plate with a second bracket of the present invention.

### DETAILED DESCRIPTIONS OF THE INVENTION

All illustrations of the drawings are for the purpose of describing selected versions of the present invention and are not intended to limit the scope of the present invention.

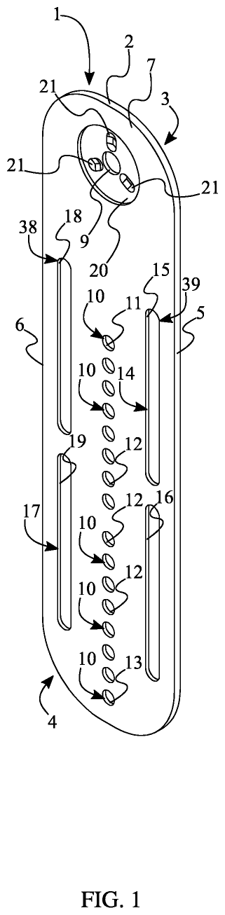

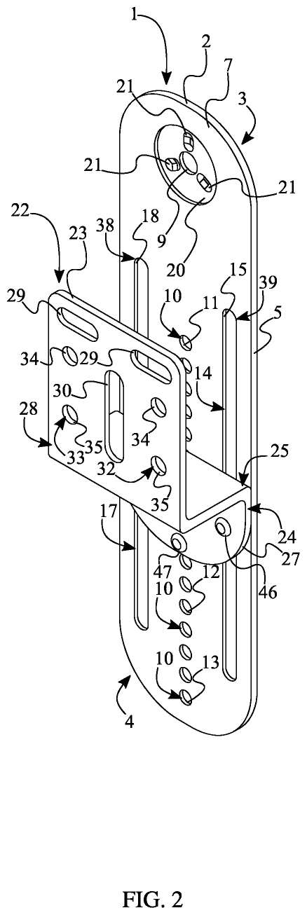

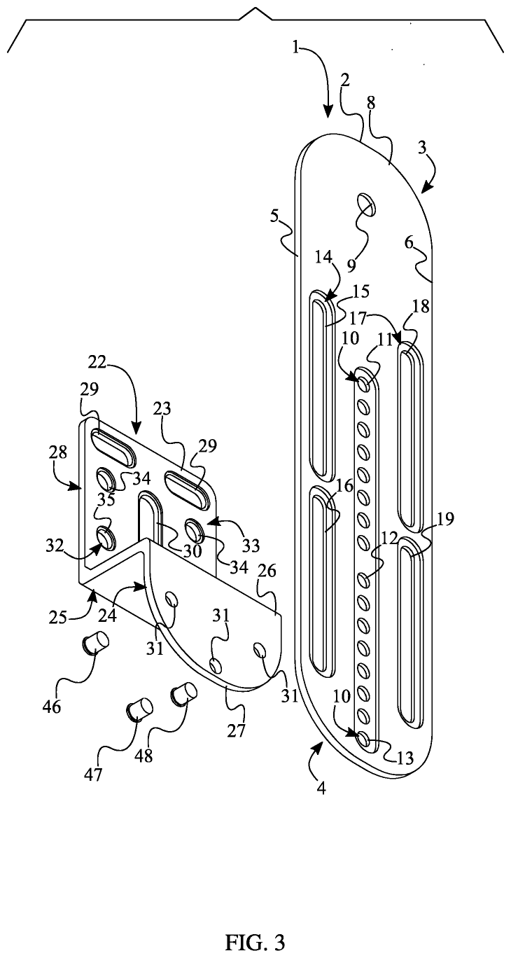

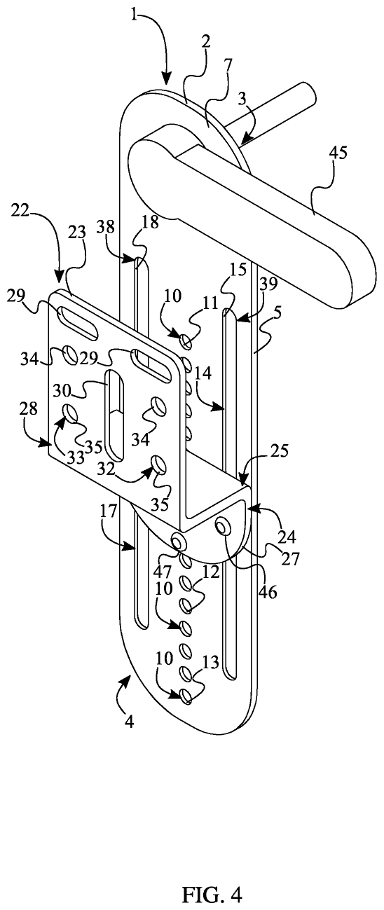

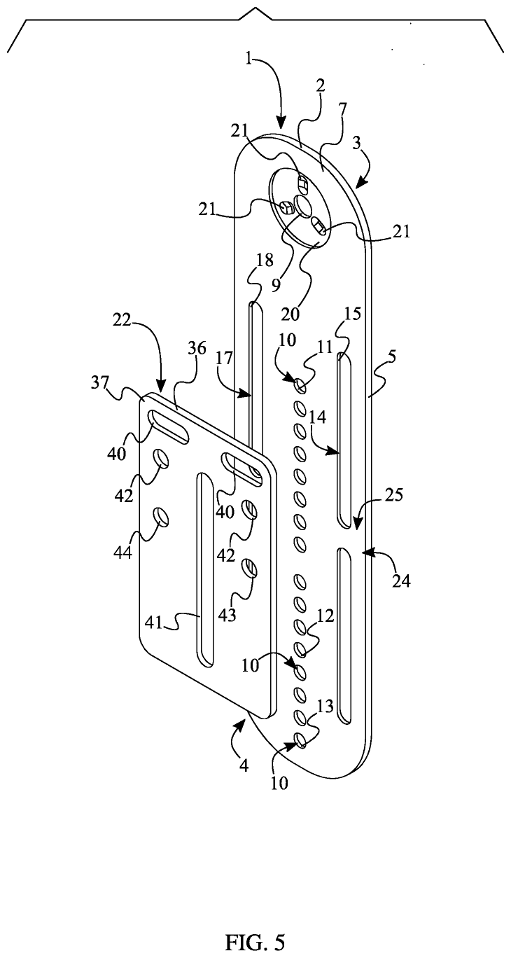

The present invention is a universal mounting panel for a motorcycle saddlebag. The present invention attaches a variety of accessories within a motorcycle saddlebag such as a holster, gear bag, pouches, and a variety of other body-worn load bearing equipment. The present invention secures the position of a desired accessory within the saddlebag, thereby facilitating access of specific items and maintaining organization within the saddlebag. In order for the present invention to uphold a saddlebag accessory within a saddlebag, the present invention may comprise an adapter plate 1 and at least one bracket 22, seen in FIG. 1, FIG. 2, FIG. 3, FIG. 4, and FIG. 5. The adapter plate 1 mounts the at least one bracket 22 into the saddlebag. The at least one bracket 22 attaches a saddlebag accessory onto the adapter plate 1. The adapter plate 1 and the at least one bracket 22 are preferably made of aluminum material or comparable structurally sound and rigid materials. The adapter plate 1 may comprise an elongated plate body 2, a main hole 9, a plurality of first mounting holes 10, at least one left slot 14, and at least one right slot 17. The elongated plate body 2 allows the at least one bracket 22 to connect with the saddlebag while preserving the structural integrity of the saddlebag. The main hole 9 allows the elongated plate body 2 to be connected with the saddlebag while preserving the structural integrity of the elongated plate body 2. The plurality of first mounting holes 10 allows the at least one bracket 22 to be positioned at varying heights along the elongated plate body 2. The at least one left slot 14 and the at least one right slot 17 secures the desired orientation of the at least one bracket 22 with the elongated plate body 2. The elongated plate body 2 is secure with both the saddlebag and the at least one bracket 22 as the elongated plate body 2 may comprise a first plate end 3, a second plate end 4, a first lengthwise edge 5, and a second lengthwise edge 6. The first plate end 3 attaches the elongated plate body 2 with the saddlebag. The distance between the first plate end 3 and the second plate end 4 provides multiple positions for the at least one bracket 22 and defines the overall height for the elongated plate body 2. Likewise, the distance between the first lengthwise edge 5 and the second lengthwise edge 6 defines the width of the elongated plate body 2.

The overall configuration of the aforementioned components securely connects a variety of saddlebag accessories securely within a saddlebag of a motorcycle. In order for the at least one bracket 22 to be positioned along the elongated plate body 2, the first plate end 3 and the second plate end 4 are positioned opposite to each other along the elongated plate body 2, seen in FIG. 1, FIG. 2, and FIG. 3. Similarly, in order for the elongated plate body 2 to traverse across the elongated plate body 2, the first lengthwise edge 5 and the second lengthwise edge 6 are positioned opposite to each other across the elongated plate body 2. In order for the elongated plate body 2 to be fastened with a saddlebag and the at least one bracket 22 to be fastened with the elongated plate body 2, the main hole 9, the plurality of first mounting holes 10, the at least one left slot 14, and the at least one right slot 17 traverses through the elongated plate body 2. More specifically, the main hole 9 is positioned adjacent to the first plate end 3. The plurality of first mounting holes 10, the at least one left slot 14, and the at least one right slot 17 are positioned offset from the first plate end 3, thereby offsetting the at least one bracket 22 from the connection of the elongated plate body 2 and the saddlebag. In order for the at least one bracket 22 to be oriented at the desired angle with the elongated plate body 2, the at least one left slot 14 is positioned adjacent and along the first lengthwise edge 5, and the at least one right slot 17 is positioned adjacent and along the second lengthwise edge 6. The plurality of first mounting holes 10 is positioned in between the at least one left slot 14 and the at least one right slot 17, thereby securing a desired position of the at least one bracket 22 along the elongated plate body 2. More specifically, the plurality of first mounting holes 10 is serially distributed along the elongated plate body 2, providing varying height options for the at least one bracket 22 within the saddlebag. In the preferred embodiment of the present invention, the plurality of first mounting holes 10 comprises a first set of mounting holes and a second set of mounting holes. The first set of mounting holes is positioned in between the second set of mounting holes and the main hole 9. In order for a variety of saddlebag accessories to interchanged with the present invention, the at least one bracket 22 is removably attached with the elongated plate body 2.

The elongated plate body 2 is quickly mounted and removed from within a saddlebag as the present invention may further comprise a twist lock 45, seen in FIG. 4. In the preferred embodiment of the present invention, the twist lock 45 is a screw with a handlebar to allow a user to easily maneuver the twist lock 45. In order for the twist lock 45 to be further secured with the elongated plate body 2, the adapter plate 1 may further comprise an annular recessed space 20 and a plurality of notches 21. The annular recessed space 20 serves as a bed for a head portion of the twist lock 45. The plurality of notches 21 accommodates the ratcheting connection between the head portion of the twist lock 45 with the elongated plate body 2. In the preferred embodiment of the present invention, the plurality of notches 21 comprises a first notch, a second notch, and a third notch. It is understood in various embodiments of the present invention that the plurality of notches 21 comprises varying amounts of notches. In an alternate embodiment of the present invention, the head of the twist lock 45 simply presses against the annular recessed space 20. In this alternate embodiment, the elongated plate body 2 comprises only the annular recessed space 20 without the plurality of notches 21. Moreover, the elongated plate body 2 may further comprise a first plate face 7 and a second plate face 8. The first plate face 7 is oriented towards the at least one bracket 22, and the second plate face 8 presses against the saddlebag. More specifically, the first plate face 7 and the second plate face 8 are positioned opposite to each other about the elongated plate body 2. The annular recessed space 20 traverses into the first plate face 7 so that the head of the twist lock 45 is flushed with the elongated plate body 2 when in a locked configuration with the adapter plate 1 and the saddlebag. A shaft of the twist lock 45 is threadedly engaged and continuously traverses through the main hole 9 as the main hole 9 is centrally positioned within the annular recessed space 20. The plurality of notches 21 traverses into the annular recessed space 20, accommodating the ratcheting connection between the twist lock 45 and the elongated plate body 2. More specifically, the plurality of notches 21 is distributed around the main hole 9. In order for the twist lock 45 to lock the adapter plate 1 with the saddle back and secure the desired orientation of the adapter plate 1 within the saddlebag, the twist lock 45 is pressed against the annular recessed space 20 and the plurality of notches 21. Furthermore, the twist lock 45 is engaged through the main hole 9, thereby upholding the twist lock 45 within the saddlebag.

Furthermore, in the preferred embodiment of the present invention, the adapter plate 1 comprises a plurality of supplementary annular recessed spaces, at least one left peripheral recessed space, and at least one right peripheral recessed space, seen in FIG. 2. The plurality of supplementary annular recessed spaces, the at least one left peripheral recessed space, and at least one right peripheral recessed space allows a variety of fasteners, preferably screws to be flushed with the elongated plate body 2 while connecting the at least one bracket 22 with the adapter plate 1. The plurality of supplementary annular recced spaces, the at least one left peripheral recessed space, and the at least one right peripheral recessed space traverses into the second plate face 8. Each mounting hole of the plurality of first mounting holes 10 is centrally positioned within a corresponding recessed space of the plurality of supplementary annular recessed spaces. The at least one left slot 14 is centrally positioned within the at least one left peripheral recessed space. Likewise, the at least one right slot 17 is centrally positioned within the at least one right peripheral recessed space.

In the preferred embodiment of the present invention, the at least one left slot 14 comprises a first left slot 15 and a second left slot 16, seen in FIG. 1, FIG. 2, FIG. 3, FIG. 4, and FIG. 5. The first left slot 15 accommodates a variety of angles for the at least one bracket 22 along the upper half of the elongated plate body 2, and the second left slot 16 accommodates a variety of angles for the at least one bracket 22 along the lower half of the elongated plate body 2. The first left slot 15 is positioned across the upper half of the elongated plate body 2 as the first left slot 15 is positioned in between the main hole 9 and the second left slot 16. More specifically, the first left slot 15 is positioned colinear with the second left slot 16.

Likewise, in the preferred embodiment of the present invention, the at least one right slot 17 comprises a first right slot 18 and a second right slot 19, seen in FIG. 1, FIG. 2, FIG. 3, FIG. 4, and FIG. 5. The first right slot 18 accommodates a variety of angles for the at least one bracket 22 along the upper half of the elongated plate body 2, and the second right slot 19 accommodates a variety of angles for the at least one bracket 22 along the lower half of the elongated plate body 2. The first right slot 18 is positioned across the upper half of the elongated plate body 2 as the first right slot 18 is positioned in between the main hole 9 and the second right slot 19. More specifically, the first right slot 18 is positioned colinear with the second right slot 19.

Furthermore, for the present invention, the plurality of first mounting holes 10 may comprise a proximal hole 11, at least one intermediate hole 12, and a distal hole 13, seen in FIG. 1, FIG. 2, FIG. 3, FIG. 4, and FIG. 5. The proximal hole 11 defines the highest height for the at least one bracket 22 along the elongated plate body 2. The at least one intermediate hole 12 defines intermediate positions for the at least one bracket 22 along the elongated plate body 2. The distal hole 13 defines the lowest height for the at least one bracket 22 along the elongated plate body 2. The at least one bracket 22 is positioned closest to an opening of the saddlebag and at the highest point along the elongated plate body 2 as the proximal hole 11 is positioned adjacent with the main hole 9. The at least one intermediate hole 12 is positioned in between the proximal hole 11 and the distal hole 13, thereby allowing the at least one bracket 22 to be positioned along the elongated plate body 2. The at least one bracket 22 is positioned at the lowest point along the elongated plate body 2 as the distal hole 13 is positioned adjacent to the second plate end 4. More specifically, the proximal hole 11, the at least one intermediate hole 12, and the distal hole 13 are positioned colinear with each other. The twist lock 45 remains uninhibited by the at least one bracket 22 as the proximal hole 11 is positioned offset from a first slot end 38 of the at least one left slot 14 and a second slot 39 end of the at least one right slot 17. Moreover, the first slot end 38 and the second slot 39 end are positioned in between the main hole 9 and the proximal hole 11, thereby allowing the at least one bracket 22 to be angled as desired while secured into the proximal hole 11.

A saddlebag accessory is fixed onto and offset from the adapter plate 1 as the at least one bracket 22 may comprise a first bracket 23, seen in FIG. 2, FIG. 3, and FIG. 4. The first bracket 23 is preferably made of aluminum material as well. In order to offset the saddlebag accessory, the first bracket 23 may comprise a first mounting plate 24, a connecting plate 25, a second mounting plate 28, a pair of ancillary slots 29, a main slot 30, a plurality of second mounting holes 31, at least one left side hole 32, and at least one right side hole 33. The first mounting plate 24 connects the first bracket 23 with the elongated plate body 2. The connecting plate 25 connects the first mounting plate 24 with the second mounting plate 28. Furthermore, the connecting plate 25 defines the distance between the elongated plate body 2 and the saddlebag accessory. The second mounting plate 28 connects the saddlebag accessory with the first bracket 23. The pair of ancillary slots 29, the main slot 30, the at least one left side hole 32, and the at least one right side hole 33 serve as connection points for a variety of saddlebag accessories. The plurality of second mounting holes 31 serves as connection points between the first bracket 23 and the elongated plate body 2. In order for the first bracket 23 to effectively support the saddlebag accessory, the first mounting plate 24 is connected perpendicular and adjacent with the connecting plate 25. The second mounting plate 28 is connected perpendicular and adjacent with the connecting plate 25, opposite the first mounting plate 24, thereby offsetting the saddlebag accessory with the elongated plate body 2. More specifically, the second mounting plate 28 is oriented away from the first mounting plate 24, facilitating the attachment and removal of the saddlebag accessory with the second mounting plate 28 while the first bracket 23 remains connected with the elongated plate body 2. Furthermore, this arrangement preserves the structural integrity of the first bracket 23. In order to fasten the saddlebag accessory with the first bracket 23, the pair of ancillary slots 29, the main slot 30, the at least one left side hole 32, and the at least one right side hole 33 traverse through the second mounting plate 28. Likewise, in order to fasten the first bracket 23 with the elongated plate body 2, the plurality of second mounting holes 31 traverses through the first mounting plate 24. The first bracket 23 is interchangeable as the first mounting plate 24 is removably attached with the elongated plate body 2.

Similar with the adapter plate 1, the first bracket 23 may further comprise a plurality of recessed spaces that traverse into the second mounting plate 28, seen in FIG. 3. The second mounting plate 28 may further comprise a first face and a second face. The second face is oriented towards the first mounting plate 24, and the plurality of recessed spaces traverse into the second face. The plurality of recessed spaces allows a variety of fasteners to be flushed with the second mounting plate 28 while connecting a saddlebag accessory with the first bracket 23. The pair of ancillary slots 29, the main slot 30, the at least one left side hole 32, and the at least one right side hole 33 are centrally positioned within each recessed space of the plurality of recessed spaces, respectively.

In the preferred embodiment of the present invention, the at least one left side hole 32 and the at least one right side hole 33 each comprise a first side hole 34 and a second side hole 35, seen in FIG. 2, FIG. 3, and FIG. 4. The first side hole 34 and the second side hole 35 allow for varying connection points for a variety of saddlebag accessory. More specifically, the pair of ancillary slots 29 is positioned offset from the connecting plate 25. The first side hole 34 is positioned adjacent with the pair of ancillary slots 29. The second side hole 35 is positioned adjacent with the first side hole 34, opposite the pair of ancillary slots 29. The first side hole 34 and the second side hole 35 are preferably threaded. Furthermore, the pair of ancillary slots 29 is positioned colinear with each other. The main slot 30 is positioned offset from the pair of ancillary slots 29. The main slot 30 is positioned in between the pair of ancillary slots 29. The main slot 30 is positioned perpendicular with the pair of ancillary slots 29. The main slot 30 is positioned in between the at least one left side hole 32 and the at least one right side hole 33.

In order to secure the first bracket 23 with the adapter plate 1, the present invention preferably comprises a first fastener 46, a second fastener 47, and a third fastener 48, seen in FIG. 2, FIG. 3, and FIG. 4. The first fastener 46, the second fastener 47, and the third fastener 48 are preferably screws. The first connecting plate 25 may also comprise a linear edge 26 and a convex edge 27. The connecting plate 25 evenly traverses across the first mounting plate 24 across the linear edge 26. The convex edge 27 prevents the first mounting plate 24 from extending past the first lengthwise edge 5 and the second lengthwise edge 6 of the elongated plate body 2 while the first bracket 23 is tilted with the adapter plate 1. The linear edge 26 and the convex edge 27 are positioned opposite to each other across the first connecting plate 25. The linear edge 26 is connected adjacent with the connecting plate 25, maintaining an upright and linear arrangement between the first mounting plate 24 and the second mounting plate 28. In order for the first mounting plate 24 to be securely connected across the elongated plate body 2, the plurality of second mounting holes 31 is peripherally distributed about the convex edge 27. The desired orientation of the first bracket 23 is secured with the elongated plate body 2 as the first fastener 46 is engaged through a selected hole from the plurality of second mounting holes 31 and the at least one left slot 14, and the second fastener 47 is engaged through a selected hole from the plurality of second mounting holes 31 and the at least one right slot 17. The desired position of the first bracket 23 is secure along the elongated plate body 2 as the third fastener 48 is engaged through a selected hole from the plurality of second mounting holes 31 and a selected hole from the plurality of first mounting holes 10.

A saddlebag accessory maybe mounted onto the adapter plate 1 with a movable joint as the at least one bracket 22 may further comprise a second bracket 36, seen in FIG. 5. The second bracket 36 connects a variety of saddlebag accessories with a variety of movable joints. The second bracket 36 is preferably made of aluminum material as well. In order to uphold a saddlebag accessory, the second bracket 36 may comprise a main mounting plate 37, a pair of ancillary slots 40, a main slot 41, a pair of second mounting holes 42, a left side hole 43, and a right side hole 44. The main mounting plate 37 connects the saddlebag accessory with the second bracket 36. The pair of mounting holes connects the second bracket 36 with the elongated plate body 2. The pair of ancillary slots 40, the main slot 41, the left side hole 43, and the right side hole 44 serve as connection points for a variety of saddlebag accessories and moveable joints. In order to fasten the saddlebag accessory and the moveable joint with the second bracket 36, the pair of ancillary slots 40, the main slot 41, the pair of second mounting holes 42, the left side hole 43, and the right side hole 44 traverse through the main mounting plate 37. The second bracket 36 is interchangeable as the main mounting plate 37 is removably attached with the elongated plate body 2.

Similar with the adapter plate 1 and the first bracket 23, the second bracket 36 may further comprise a plurality of recessed spaces that traverse into the main mounting plate 37, seen in FIG. 5. The main mounting plate 37 may further comprise a first face and a second face. The main face is oriented towards the adapter plate 1, and the plurality of recessed spaces traverse into the second face. The plurality of recessed spaces allows a variety of fasteners to be flushed with the main mounting plate 37 mounting plate while connecting a saddlebag accessory with the second bracket 36. The pair of ancillary slots 40, the main slot 41, the pair of second mounting holes 42, the left side hole 43, and the right side hole 44 are centrally positioned within each recessed space of the plurality of recessed spaces, respectively.

In the preferred embodiment of the present invention, the pair of ancillary slots 40 is peripherally positioned with the main mounting plate 37. The pair of ancillary slots 40 is positioned colinear with each other. The main slot 41 is positioned offset from the pair of ancillary slots 40. The main slot 41 is positioned in between the pair of ancillary slots 40. The main slot 41 is positioned perpendicular with the pair of ancillary slots 40. The main slot 41 is positioned in between the pair of second mounting holes 42. The main slot 41 is positioned in between the left side hole 43 and the right side hole 44. The pair of second mounting holes 42 is positioned in between the pair of ancillary slots 40 and both the left side hole 43 and the second side hole 35. This arrangement provides the necessary connection points for various saddlebag accessories and movable joints simultaneously.

Although the invention has been explained in relation to its preferred embodiment, it is to be understood that many other possible modifications and variations can be made without departing from the spirit and scope of the invention as hereinafter claimed.

What is claimed is:

1. A universal mounting panel for a motorcycle saddlebag comprising:
an adapter plate;
at least one bracket;
the adapter plate comprising an elongated plate body, a main hole, a plurality of first mounting holes, at least one left slot, and at least one right slot;
the elongated plate body comprising a first plate end, a second plate end, a first lengthwise edge, and a second lengthwise edge;
the first plate end and the second plate end being positioned opposite to each other along the elongated plate body;
the first lengthwise edge and the second lengthwise edge being positioned opposite to each other across the elongated plate body;
the main hole, the plurality of first mounting holes, the at least one left slot, and the at least one right slot traversing through the elongated plate body;
the main hole being positioned adjacent to the first plate end;
the plurality of first mounting holes, the at least one left slot and the at least one right slot being positioned offset from the first plate end;
the at least one left slot being positioned adjacent and along the first lengthwise edge;
the at least one right slot being positioned adjacent and along the second lengthwise edge;
the plurality of first mounting holes being positioned in between the at least one left slot and the at least one right slot;
the plurality of first mounting holes being serially distributed along the elongated plate body; and,
the at least one bracket being removably attached with the elongated plate body.

2. The universal mounting panel for a motorcycle saddlebag as claimed in claim 1 comprising:
a twist lock;
the adapter plate further comprising an annular recessed space and a plurality of notches;
the elongated plate body further comprising a first plate face and a second plate face;
the first plate face and the second plate face being positioned opposite to each other about the elongated plate body;
the annular recessed space traversing into the first plate face;
the main hole being centrally positioned within the annular recessed space;
the plurality of notches traversing into the annular recessed space;
the plurality of notches being distributed around the main hole;
the twist lock being pressed against the annular recessed space and the plurality of notches; and,
the twist lock being engaged through the main hole.

3. The universal mounting panel for a motorcycle saddlebag as claimed in claim 1 comprising:
the at least one left slot comprising a first left slot and a second left slot;
the first left slot being positioned in between the main hole and the second left slot; and,
the first left slot being positioned colinear with the second left slot.

4. The universal mounting panel for a motorcycle saddlebag as claimed in claim 1 comprising:
the at least one right slot comprising a first right slot and a second right slot;
the first right slot being positioned in between the main hole and the second right slot; and,
the first right slot being positioned colinear with the second right slot.

5. The universal mounting panel for a motorcycle saddlebag as claimed in claim 1 comprising:
the plurality of first mounting holes comprising a proximal hole, at least one intermediate hole, and a distal hole;
the proximal hole being positioned adjacent with the main hole;
the at least one intermediate hole being positioned in between the proximal hole and the distal hole;
the distal hole being positioned adjacent to the second plate end;
the proximal hole, the at least one intermediate hole, and the distal hole being positioned colinear with each other;
the proximal hole being positioned offset from a first slot end of the at least one left slot and a second slot end of the at least one right slot; and,
the first slot end and the second slot end being positioned in between the main hole and the proximal hole.

6. The universal mounting panel for a motorcycle saddlebag as claimed in claim 1 comprising:
the at least one bracket comprising a first bracket;
the first bracket comprising a first mounting plate, a connecting plate, a second mounting plate, a pair of ancillary slots, a main slot, a plurality of second mounting holes, at least one left side hole, and at least one right side hole;
the first mounting plate being connected perpendicular and adjacent with the connecting plate;
the second mounting plate being connected perpendicular and adjacent with the connecting plate, opposite the first mounting plate;
the second mounting plate being oriented away from the first mounting plate;
the pair of ancillary slots, the main slot, the at least one left side hole, and the at least one right side hole traversing through the second mounting plate;
the plurality of second mounting holes traversing through the first mounting plate; and,
the first mounting plate being removably attached with the elongated plate body.

7. The universal mounting panel for a motorcycle saddlebag as claimed in claim 6 comprising:
the at least one left side hole and the at least one right side hole each comprising a first side hole and a second side hole;
the pair of ancillary slots being positioned offset from the connecting plate;
the first side hole being positioned adjacent with the pair of ancillary slots; and,
the second side hole being positioned adjacent with the first side hole, opposite the pair of ancillary slots.

8. The universal mounting panel for a motorcycle saddlebag as claimed in claim 6 comprising:
the pair of ancillary slots being positioned offset from the connecting plate;
the pair of ancillary slots being positioned colinear with each other;
the main slot being positioned offset from the pair of ancillary slots;
the main slot being positioned in between the pair of ancillary slots;
the main slot being positioned perpendicular with the pair of ancillary slots; and,
the main slot being positioned in between the at least one left side hole and the at least one right side hole.

9. The universal mounting panel for a motorcycle saddlebag as claimed in claim 6 comprising:
a first fastener;
a second fastener;
a third fastener;
the first connecting plate comprising a linear edge and a convex edge;
the linear edge and the convex edge being positioned opposite to each other across the first connecting plate;
the linear edge being connected adjacent with the connecting plate;
the plurality of second mounting holes being peripherally distributed about the convex edge;
the first fastener being engaged through a selected hole from the plurality of second mounting holes and the at least one left slot;
the second fastener being engaged through a selected hole from the plurality of second mounting holes and the at least one right slot; and,
the third fastener being engaged through a selected hole from the plurality of second mounting holes and a selected hole from the plurality of first mounting holes.

10. The universal mounting panel for a motorcycle saddlebag as claimed in claim 1 comprising:
the at least one bracket comprising a second bracket;
the second bracket comprising a main mounting plate, a pair of ancillary slots, a main slot, a pair of second mounting holes, a left side hole, and a right side hole;
the pair of ancillary slots, the main slot, the pair of second mounting holes, the left side hole, and the right side hole traversing through the main mounting plate; and,
the main mounting plate being removably attached with the elongated plate body.

11. The universal mounting panel for a motorcycle saddlebag as claimed in claim 10 comprising:
the pair of ancillary slots being peripherally positioned with the main mounting plate;
the pair of ancillary slots being positioned colinear with each other;
the main slot being positioned offset from the pair of ancillary slots;
the main slot being positioned in between the pair of ancillary slots;
the main slot being positioned perpendicular with the pair of ancillary slots;
the main slot being positioned in between the pair of second mounting holes;
the main slot being positioned in between the left side hole and the right side hole; and,
the pair of second mounting holes being positioned in between the pair of ancillary slots and both the left side hole and the second side hole.

12. A universal mounting panel for a motorcycle saddlebag comprising:
an adapter plate;
at least one bracket;
a twist lock;
the adapter plate comprising an elongated plate body, a main hole, a plurality of first mounting holes, at least one left slot, at least one right slot, an annular recessed space, and a plurality of notches;
the elongated plate body comprising a first plate end, a second plate end, a first lengthwise edge, a second lengthwise edge, a first plate face, and a second plate face;
the first plate end and the second plate end being positioned opposite to each other along the elongated plate body;
the first lengthwise edge and the second lengthwise edge being positioned opposite to each other across the elongated plate body;
the main hole, the plurality of first mounting holes, the at least one left slot, and the at least one right slot traversing through the elongated plate body;
the main hole being positioned adjacent to the first plate end;
the plurality of first mounting holes, the at least one left slot and the at least one right slot being positioned offset from the first plate end;
the at least one left slot being positioned adjacent and along the first lengthwise edge;
the at least one right slot being positioned adjacent and along the second lengthwise edge;
the plurality of first mounting holes being positioned in between the at least one left slot and the at least one right slot;
the plurality of first mounting holes being serially distributed along the elongated plate body;
the at least one bracket being removably attached with the elongated plate body;
the first plate face and the second plate face being positioned opposite to each other about the elongated plate body;
the annular recessed space traversing into the first plate face;
the main hole being centrally positioned within the annular recessed space;
the plurality of notches traversing into the annular recessed space;
the plurality of notches being distributed around the main hole;
the twist lock being pressed against the annular recessed space and the plurality of notches; and,
the twist lock being engaged through the main hole.

13. The universal mounting panel for a motorcycle saddlebag as claimed in claim 12 comprising:
the at least one left slot comprising a first left slot and a second left slot;
the first left slot being positioned in between the main hole and the second left slot; and,
the first left slot being positioned colinear with the second left slot.

14. The universal mounting panel for a motorcycle saddlebag as claimed in claim 12 comprising:
the at least one right slot comprising a first right slot and a second right slot;
the first right slot being positioned in between the main hole and the second right slot; and,
the first right slot being positioned colinear with the second right slot.

15. The universal mounting panel for a motorcycle saddlebag as claimed in claim 12 comprising:
the plurality of first mounting holes comprising a proximal hole, at least one intermediate hole, and a distal hole;
the proximal hole being positioned adjacent with the main hole;
the at least one intermediate hole being positioned in between the proximal hole and the distal hole;
the distal hole being positioned adjacent to the second plate end;
the proximal hole, the at least one intermediate hole, and the distal hole being positioned colinear with each other;
the proximal hole being positioned offset from a first slot end of the at least one left slot and a second slot end of the at least one right slot; and,
the first slot end and the second slot end being positioned in between the main hole and the proximal hole.

16. The universal mounting panel for a motorcycle saddlebag as claimed in claim 12 comprising:
the at least one bracket comprising a first bracket;
the first bracket comprising a first mounting plate, a connecting plate, a second mounting plate, a pair of ancillary slots, a main slot, a plurality of second mounting holes, at least one left side hole, and at least one right side hole;
the at least one left side hole and the at least one right side hole each comprising a first side hole and a second side hole;
the first mounting plate being connected perpendicular and adjacent with the connecting plate;
the second mounting plate being connected perpendicular and adjacent with the connecting plate, opposite the first mounting plate;
the second mounting plate being oriented away from the first mounting plate;
the pair of ancillary slots, the main slot, the at least one left side hole, and the at least one right side hole traversing through the second mounting plate;
the plurality of second mounting holes traversing through the first mounting plate;
the first mounting plate being removably attached with the elongated plate body;
the pair of ancillary slots being positioned offset from the connecting plate;
the first side hole being positioned adjacent with the pair of ancillary slots;
the second side hole being positioned adjacent with the first side hole, opposite the pair of ancillary slots;
the pair of ancillary slots being positioned offset from the connecting plate;
the pair of ancillary slots being positioned colinear with each other;
the main slot being positioned offset from the pair of ancillary slots;
the main slot being positioned in between the pair of ancillary slots;
the main slot being positioned perpendicular with the pair of ancillary slots; and,
the main slot being positioned in between the at least one left side hole and the at least one right side hole.

17. The universal mounting panel for a motorcycle saddlebag as claimed in claim 16 comprising:
a first fastener;
a second fastener;
a third fastener;
the first connecting plate comprising a linear edge and a convex edge;
the linear edge and the convex edge being positioned opposite to each other across the first connecting plate;
the linear edge being connected adjacent with the connecting plate;
the plurality of second mounting holes being peripherally distributed about the convex edge;
the first fastener being engaged through a selected hole from the plurality of second mounting holes and the at least one left slot;
the second fastener being engaged through a selected hole from the plurality of second mounting holes and the at least one right slot; and,
the third fastener being engaged through a selected hole from the plurality of second mounting holes and a selected hole from the plurality of first mounting holes.

18. The universal mounting panel for a motorcycle saddlebag as claimed in claim 12 comprising:
the at least one bracket comprising a second bracket;
the second bracket comprising a main mounting plate, a pair of ancillary slots, a main slot, a pair of second mounting holes, a left side hole, and a right side hole;
the pair of ancillary slots, the main slot, the pair of second mounting holes, the left side hole, and the right side hole traversing through the main mounting plate;
the main mounting plate being removably attached with the elongated plate body;
the pair of ancillary slots being peripherally positioned with the main mounting plate;
the pair of ancillary slots being positioned colinear with each other;
the main slot being positioned offset from the pair of ancillary slots;
the main slot being positioned in between the pair of ancillary slots;
the main slot being positioned perpendicular with the pair of ancillary slots;
the main slot being positioned in between the pair of second mounting holes;
the main slot being positioned in between the left side hole and the right side hole; and,
the pair of second mounting holes being positioned in between the pair of ancillary slots and both the left side hole and the second side hole.
